(19) United States
(12) Patent Application Publication
(10) Pub. No.: US 2023/0133948 A1
(43) Pub. Date: May 4, 2023

(54) ADJUSTMENT OF DISPLAY SETTINGS

(71) Applicant: HEWLETT-PACKARD DEVELOPMENT COMPANY, L.P., SPRING, TX (US)

(72) Inventors: CHIA-CHENG LIN, TAIPEI CITY (TW); HUNG-LUNG CHEN, TAIPEI CITY (TW); SHAO-YU CHIANG, TAIPEI CITY (TW)

(21) Appl. No.: 17/996,138

(22) PCT Filed: Apr. 22, 2020
(86) PCT No.: PCT/US2020/029214

§ 371 Date: Oct. 13, 2022

(51) Int. Cl. G09G 3/20

(52) U.S. Cl. CPC G09G 3/2096; G09G 2370/22; G09G 2320/0606; G06F 13/4282

(57) ABSTRACT

Examples of computing devices for adjusting a display setting of an external display device are described herein. In an example, a computing device may include a power delivery (PD) controller that may transmit the display setting to the external display device, upon detecting that the external display device is connected to the computing device. In an example, the display setting may be transmitted in accordance with a Universal Serial Bus (USB) PD protocol. Once the external display device has adjusted a display panel based on the display setting, an acknowledgement may be sent to the PD controller.

### BACKGROUND

Computing devices, such as laptops, notebooks, etc., may be connected to external electronic devices, such as external display devices. The external electronic devices may be connected to the computing devices using a Universal Serial Bus (USB) Type-C standard.

### BRIEF DESCRIPTION OF FIGURES

The detailed description is provided with reference to the accompanying figures, wherein:

FIG. 1 illustrates a computing device for adjusting display settings of an external display device, according to an example;

FIG. 2 illustrates a computing device for adjusting display settings an external display device, according to an example;

FIG. 3 illustrates a computing device for adjusting display settings an external display device, according to an example;

FIG. 4 illustrates a call flow diagram for adjusting display settings an external display device, according to an example; and

FIG. 5 illustrates a non-transitory computer readable medium for adjusting display settings an external display device, according to an example.

### DETAILED DESCRIPTION

A computing device, such as a laptop computer, a notebook, etc., may be connected to an external electronic device, such as a display device, an input device, and so on. In an example, the computing device may be connected to the external electronic device through a Universal Serial Bus (USB) Type-C port. In an example, to simultaneously access multiple applications or documents, a user may connect the computing device to the external display device.

As the external display device may have preset display settings, the user may wish to change or adjust the preset display settings of the external display device. To do so, the user may access an interface, such as an on-screen display (OSD) menu, of the external display device. For example, the user may change a brightness setting, a contrast setting, and so on, from the OSD menu of the external display device. This may be time-consuming and inconvenient to the user.

The present subject matter discloses example approaches for adjusting display settings of an external display device from a computing device (host). The computing device may communicate with the external display device by using USB power delivery (PD) protocol-based messages, to adjust the display settings of the external display device.

The present subject matter proposes a technique for adjusting display settings of an external display device, such as a docking monitor. For example, a computing device may be connected to the external display device through a Universal Serial Bus (USB) Type-C port. Upon detection that the external display device is connected to the computing device, a power delivery (PD) controller of the computing device may transmit a display setting to the external display device. The PD controller may manage connections and messaging at the USB Type-C port of the computing device, In an example, the PD controller may embed the display setting in a USB PD protocol-based message, such as a vendor defined message (VDM) command. The VDM command may be a signal allocated by a manufacturer of a computing device or an external display device, The VDM command may be used for controlling a signal transmitted and received between the external display device and the computing device.

The PD controller may thereafter transmit the USB PD protocol-based message to the external display device. The external display device may adjust the display setting of a display panel thereof, as per the display setting transmitted by the PD controller.

Accordingly, the present subject matter may facilitate access of the on-screen display (OSD) menu of the external display device from the computing device to adjust the display settings of the external display device. Such adjustment of the display settings may enhance user experience while multiple external electronic devices are connected to the computing device.

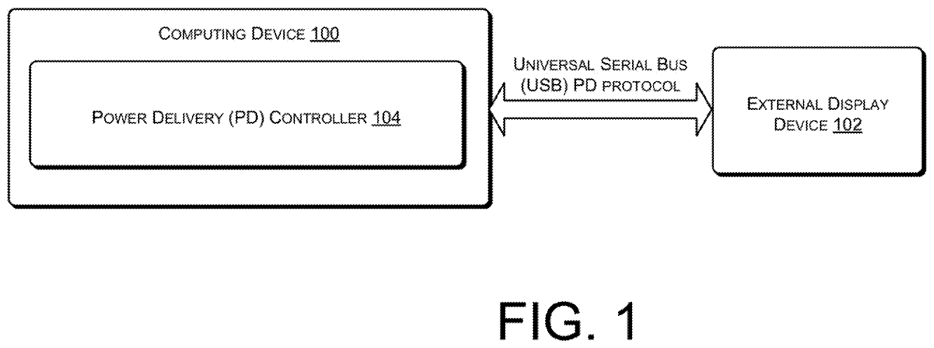

FIG. 1 illustrates a computing device 100 for adjusting display settings of an external display device 102, according to an example. The display settings may be the values set for different parameters associated with a display panel. For example, the display settings may include, but are not limited to, a brightness setting, a contrast setting, a language setting, a sharpness setting, and a position setting. Examples of the computing device 100 may include, but are not limited to, a laptop, a notebook computer, and a tablet. Further, the external display device 102 may be a monitor, such as a docking monitor. The docking monitor may include an integrated docking station to facilitate connections with multiple peripherals. The external display device 102 may be connected to the computing device 100 based on Universal Serial Bus (USB) Type-C standards.

The computing device 100 may include a power delivery (PD) controller 104 associated with a USB port (not shown). The USB port may facilitate attachment of peripheral devices, such as the external display device 102 with the computing device 100. The PD controller 104 may detect that the display device 102 is connected to the computing device 100. For example, when the display device 102 is coupled to the USB port of the computing device 100, the PD controller 104 may communicate with a corresponding component (not shown) of the external display device 102 to negotiate power transfer capabilities between the computing device 100 and the external display device 102.

In addition, upon detection of connection with the external display device 102, the PD controller 104 may transmit a display setting to the external display device 102. The display setting may indicate a setting to which the external display device 102 may adjust. In an example, the display setting may include a setting that may be included in an on-screen display (OSD) menu of the external display device 102.

In an example implementation, the PD controller 104 may share the display setting with the external display device 102 through a USB PD protocol. The USB PD protocol may specify a communication format based on which the PD controller 104 may transmit the display setting to the external display device 102. Once the external display device 102 has made adjustment in the display setting based on the display setting shared by the PD controller 104, the PD controller 104 may receive an acknowledgement from the external display device 102. The acknowledgment may indicate that the display setting shared by the computing device 100 have been adopted by the external display device 102. In an example, the external display device 102 may send the acknowledgement to the PD controller 104, as per the USB PD protocol.

The computing device 100 thus facilitates in efficiently adjusting the display setting of the external display device 102 by using USB PD protocols. The USB PD protocol may allow adjustment of the display setting from a host, such as the computing device 100, by accessing an OSD menu of the external display device 102 from the computing device 100.

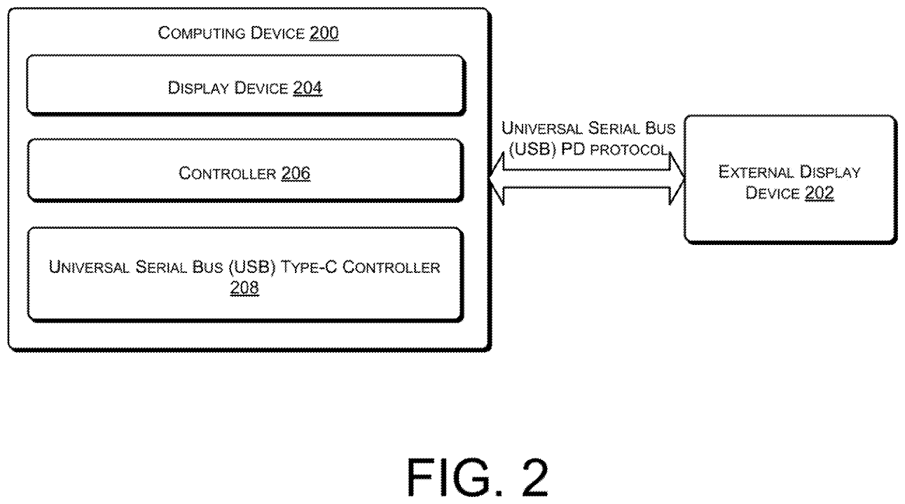

FIG. 2 illustrates a computing device 200 for adjusting display settings of an external display device 202, according to an example. In an example, the computing device 200 may be similar to the computing device 100. The computing device 200 may include a display device 204. The display device 204 may be a monitor (not shown) that may include various components that may facilitate the computing device 200 to display content. For example, the display device 204 may include a display panel (not shown). Examples of the display panel may include, but are not limited to, liquid crystal displays (LCDs), plasma displays, and light emitting diode (LED) based displays. In an example, the display panel may be a touch panel.

Further, the computing device 200 may include a controller 206. The controller 206 may be implemented as an embedded controller, a microcontroller, a microprocessor, a functional block, logic, or other circuit or collection of circuits capable of performing the functions described herein. The controller 206 may be coupled to the display device 204 of the computing device 200 to receive the display setting of the external display device 202 that may be coupled to the computing device 200.

The computing device 200 may further include a Universal Serial Bus (USB) Type-C controller 208 coupled to the display device 204 and the controller 206. In an example, the USB Type-C controller 208 may be similar to the PD controller 104. The USB Type-C controller 208 may be associated with a USB Type-C port (not shown) of the computing device 200. The USB Type-C port may facilitate connection between the computing device 200 and the external display device 204. The USB Type-C controller 208 may therefore, manage connections and messaging at the USB Type-C port of the computing device 200. In an example, the external display device 202 may be a docking monitor that may facilitate connecting other peripherals with the computing device 200.

When the external display device 204 may get connected to the computing device 200 through the USB Type-C port, the USB Type-C controller 208 may communicate with the controller 206 to obtain the display setting for the external display device 204. The display setting may include, but are not limited to, a brightness setting, a sharpness setting, and a language setting, In an example, the controller 206 may receive the display setting of the external display device 204 from a memory (not shown) of the computing device 200. In an example, the memory may be a non-volatile memory.

The USB Type-C controller 208 may embed the display setting, such as a brightness setting, in a USB Power Delivery (PD) protocol-based message. For example, the USB PD protocol-based message may include a pre-defined number of bits in a header of the message for embedding a value for the brightness setting of the external display device 202. Once embedded, the USB Type-C controller 208 may transmit the USB PD protocol-based message to the external display device 202.

Upon receiving the USB PD protocol-based message, the external display device 202 may retrieve the brightness setting embedded within the USB PD protocol-based message. The external display device 202 may adjust the brightness setting of a display panel (not shown) of the external display device 202 based on the brightness setting provided by the computing device 200.

Further, the external display device 202 may send an acknowledgement to the computing device 200. The acknowledgment may indicate that the display setting shared by the computing device 200 have been adopted by the external display device 202. In an example, the acknowledgement may be received by the USB Type-C controller 208 of the computing device 200 about adjustment of the brightness setting by the external display device 202. Upon receiving the acknowledgement, the USB Type-C controller 208 may send a confirmation message to the controller 206. The confirmation message may indicate that the brightness setting transmitted by the computing device 200 have been adopted by the external display device 202 and the brightness setting may be stored in the memory as a latest brightness setting.

Although the present subject matter is explained with reference to the brightness setting, the display setting may include any may include a setting that may be included in an on-screen display (OSD) menu of the external display device 202. Thus, the display setting is not limited to those mentioned with reference to FIG. 2 and may include the sharpness setting, a position setting, etc.

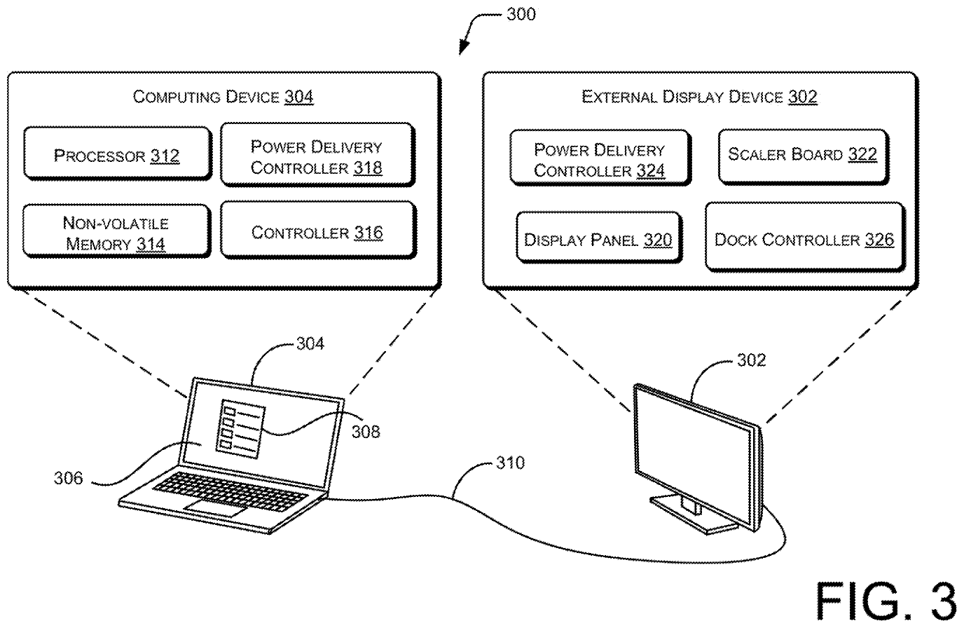

FIG. 3 illustrates a system environment 300 for adjusting display settings of an external display device 302, according to an example. The display settings may be the values set for different parameters associated with a display panel. For example, the display settings may include, but are not limited to, a brightness setting, a contrast setting, a language setting, a sharpness setting, and a position setting, a timer setting. The system environment 300 may include a computing device 304, similar to the computing device 100 and 200. Examples of the computing device 304 may include, but are not limited to, a laptop computer, a notebook computer, and a tablet. The computing device 304 may include a display device 306. The display device 306 may be similar to the display device 204. In the present example, the display device 306 may be a display screen of the computing device 304 to display data according to display setting of the computing device 304. In an example, the display device 306 may be a detachable display. For example, the display device 306 may include a display panel (not shown). Examples of the display panel may include, but are not limited to, liquid crystal displays (LCDs), plasma displays, and light emitting diode (LED) based displays. In an example, the display panel may be a touch panel.

In an example, the computing device 304 may include interface(s) 308. The interface(s) 308 may include a variety of interfaces, for example, interface(s) 308 for the external display device 302. In an example, the interface(s) 308 may include a Universal Serial Bus (USB) interface that may be used to connect the external display device 302 to the computing device 304. The interface(s) 308 may include data output devices. The interface(s) 308 may facilitate the communication of the computing device 304 with various electronic devices. In an example, the external display device 302 may be coupled to the computing device 304 through a USB cable 310.

Further, the computing device 304 may include a processor 312. The processor 312 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labeled as “processor(s)”, may be provided through the use of dedicated hardware as well as hardware capable of executing computer-readable instructions.

Any requests, for changing or adjusting the display setting, from a user of the computing device 304 may be received by the processor 312. For example, the user may access an application through which the user may adjust the display setting of the external display device 302. The user may provide input through the interface 308 of the computing device 304 to indicate the display setting based on which the external display device 302 may adjust corresponding display setting. The processor 312 may collect the input provided by the user and store the input as user-defined display setting.

Further, the computing device 304 may include a non-volatile memory 314, such as read only memory (ROM), erasable programmable ROM, flash memories, hard disks, optical disks, and magnetic tapes. The non-volatile memory 314 may be associated with a firmware (not shown), such as a Basic Input/Output System (BIOS) of the computing device 304. The NVM 314 may store a device information table and application information. The device information table may include device type information mapped to USB device information. The device information table may be used to obtain information pertaining to the external display device. The application information may include information on whether an application is to be accessed for controlling the external display device, an application type, and an address of a server for obtaining the application. Further, the NVM 314 may store any data input provided by the user of the application.

Further, the computing device 304 may include a controller 316. The controller 316 may be a microprocessor of the computing device 304, which is separate from the processor 312. The controller 316 may be in communication with the display device 306 and the processor 312 of the computing device 304. In an example, the controller 316 may be coupled to the processor 312 by a windows management instrumentation (WMI) layer. The input provided by the user and stored in the non-volatile memory 314 as the user-defined display setting, may be provided to the controller 316 through the WMI layer. In an example, the processor 312 may communicate with the controller 316 through the WMI layer. As user applications are executed at a user mode of an operating system of the computing device 304, the WMI layer may provide access of the data input by the user into the user applications. Therefore, the controller 316 may access the user input through the WMI layer.

The computing device 304 further includes a power delivery (PD) controller 318 that may be coupled to the controller 316. In an example, the PD controller 318 and the controller 316 may be connected together by an Inter-Integrated Circuit (I2C) bus. The I2C bus is a serial protocol for two-wire interface to connect low-speed devices, like rnicrocontrollers. The PD controller 318 may be associated with the USB Type-C port of the computing device 304. The USB Type-C port may facilitate connection between the computing device 304 and the external display device 302. The USB type-C port may enable different types of connections to be operable over one physical connection. For example, the same USB Type-C port may be used for transmitting data signals, display signals, and so on. The PD controller 318 may manage connections and messaging at the USB Type-C port of the computing device 304. The PD controller 318 may interchangeably be referred to as a USB Type-C controller.

In an example implementation, the PD controller 318 may communicate with the external display device 302 through a USB PD protocol. The USB PD protocol may support vendor defined messaging (VDM) commands. Thus, the PD controller 318 may communicate with the external display device 302 through the VDM commands. The VDM commands may enable vendors to specify undocumented commands to implement vendor-specific functionality. For instance, opposing PD controllers may negotiate data transfer and power transfer upon detection of physical connection at the USB Type-C port. Details pertaining to communication between the computing device 304 and the external display device 302 will be described in detail at later paragraphs of the description.

In an example implementation, the external display device 302 may be a docking monitor. The docking monitor may include an integrated docking station to facilitate connections with multiple peripherals. The external display device 302 may include a display panel 320. Examples of the display panel 320 may include, but are not limited to, liquid crystal displays (LCDs), plasma displays, and light emitting diode (LED) based displays. In an example, the display panel 320 may be a touch panel.

Further, the external display device 302 may include a scaler board 322 coupled to the display panel 320. In an example, the scaler board 322 represents front-end electronics of the external display device 302 to receive digital signals from the computing device 304. The scaler board 322 may process the digital signals to provide analog video signals to the display panel 320. The processing performed by the scaler board 322 may include image processing, such as scaling, resolution controlling, backlight controlling, and other processing of digital data.

As mentioned earlier, the external display device 302 may be coupled to the computing device 304 through the USB cable 310. The external display device 302 may include a USB Type-C port (not shown) for being coupled to a corresponding USB Type-C port of the computing device 304 for exchanging data. The corresponding USB Type-C ports may be connected together by the USB cable 310. Further, the external display device 302 may include a PD controller 324. The PD controller 324 may be associated with the USB Type-C port of the external display device 302 and may be similar to the PD controller 318.

The external display device 302 may also include a dock controller (DC) 326. The DC 326 may be a USB billboard controller that may manage USB dock and monitors. The DC 326 may manage any communication received by the PD controller 324 of the external display device 302. For example, any data message received by the PD controller 324 may be forwarded to the DC 326. The DC 326 may parse through the data messages and route the data messages to concerned components of the external display device 302. For example, when the PD controller 324 receives a data message indicating the display setting of the external display device 302, the DC 326 may forward the data message to the scaler board 322 of the external display device 302.

In operation, upon connection of the external display device 302 and the computing device 304, the USB Type-C port may send a signal to the PD controller 318. Based on the signal, the PD controller 318 may determine that the external display device 302 is connected to the computing device 304. The PD controller 318 may communicate with the PD controller 324 of the external display device 302 to negotiate power transfer capabilities between the computing device 304 and the external display device 302. Further, the PD controller 318 may communicate with the controller 316 to obtain the display setting for the external display device 302. The controller 316 may retrieve the display setting from the NVM 314 and transmit to the PD controller 318.

In an example, the display setting stored in the NVM 314 is a current display setting of the display device 306. For example, the current display setting may be a current value of display brightness, a current value of display sharpness, a current display language, and so on, that may be configured for the display device 306. In this case, the computing device 304 may synchronize the display setting of the display device 306 with the external display device 302. In another example, the display setting stored in the NVM 314 may be defined by a user of the computing device 304. For example, the user may define a particular display setting for the external display device 302 through a user application. The particular display setting may get stored in the NVM 314 which may be retrieved later by the controller 316.

Once the display setting is transmitted to the PD controller 318, the PD controller 318 may transmit the display setting to the external display device 302 via a USB PD protocol. For example, the USB PD protocol may support a vendor defined message (VDM) command. The VDM command may be a signal allocated by a manufacturer of a computing device, such as the computing device 304 or an external display device, such as the external display device 302. The VDM command may be used for controlling a signal transmitted and received between the external display device 302 and the computing device 304. The VDM command transmitted from the computing device 304 to the external display device 302 through the USB Type-C may include a manufacturer identifier of the computing device 304.

A structure of the VDM command may be defined by a PD specification of USB Type-C. Based on the structure, the VDM commands may be structured or unstructured. The structured VDM commands may be those commands that are defined by the PD specification of the USB Type-C. The unstructured VDM commands are not separately defined by the PD specification of the USB Type-C. The unstructured VDM commands may be used for transmitting messages that may be defined by vendors, such as a vendor of the computing device 304. Although the unstructured VDM commands are not defined in the PD specification, data included in the unstructured VDM commands may have a size of about 24 bytes. The present subject matter describes communication between the computing device 304 and the external display device 302 using the unstructured VDMI commands.

Referring back to the PD controller 318, upon receiving the display setting of the external display device 302, the PD controller 318 may embed the display setting in the unstructured VDM command. For example, certain bits may be reserved for the vendor to specify a message. The PD controller 318 may embed the display setting in the reserved bits of the VDM command. Further, the PD controller 318 may transmit the VDM command to the PD controller 324 of the external display device 302.

The PD controller 324 may forward the VDM command containing the display setting to the DC 326. The DC 326 may parse through the VDM command and forward the display setting mentioned in the VDM command to the scaler board 322. In an example, the DC 326 may be coupled to the scaler board 322, such that the DC 326 may provide any data pertaining to the display panel 320 to the scaler board 322 over an Inter-Integrated Circuit (I2C) serial interface portion of a video signal cable, Universal Asynchronous Receiver/Transmitter circuit (UART), Recommended Standard (RS) 232, or Universal Serial Bus (USB) connection.

The scaler board 322 may obtain the display setting from the VDM command shared by the DC 326. Based on the VDM command, the scaler board 322 may adjust the display setting of the display panel 320 to meet the display setting transmitted by the computing device 304. Upon adjustment of the display setting of the display panel 320, the scaler board 322 may send an acknowledgement to the DC 326. The DC 326 may share the acknowledgement with the PD controller 324 over an I2C bus. The PD controller 324 may accordingly communicate with the PD controller 318 of the computing device 304 to transmit the acknowledgement received from the DC 326.

Based on the acknowledgement, the PD controller 318 may send a confirmation message to the controller 316. The confirmation message may indicate that the display setting transmitted to the external display device 302 may be stored as a latest display setting of the external display device 302. The controller 316 may upon receiving the confirmation message, store the display setting of the external display device 302 in the NVM 314.

Accordingly, the present subject matter may facilitate adjustment of display settings of the external display device 302 from the computing device 304 with which the external display device 302 is coupled. A user of the computing device 304 may access the GSD menu of the docking monitor from the interface 308 to adjust the display settings of the docking monitor.

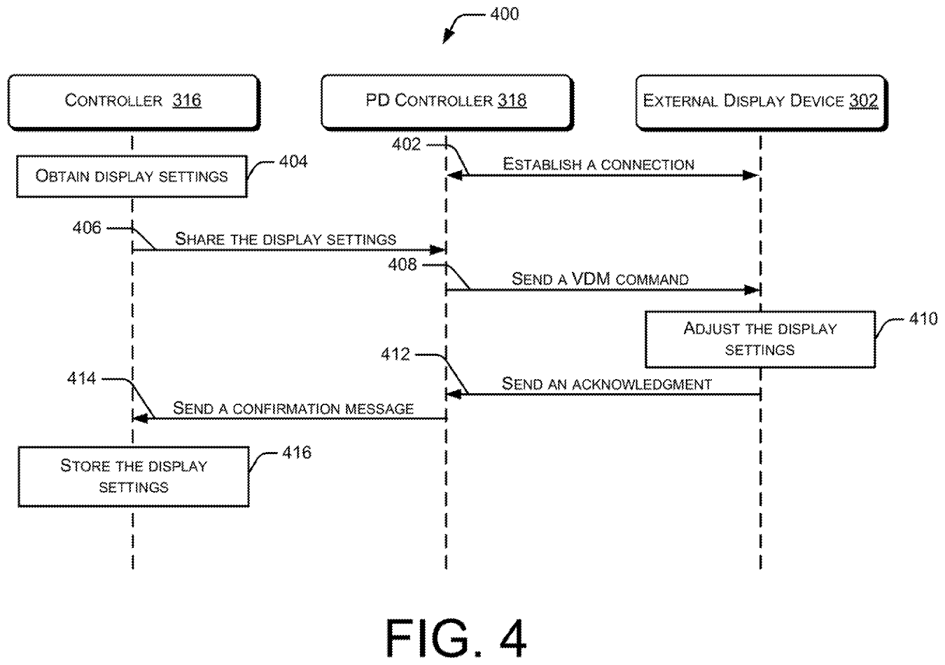

FIG. 4 illustrates a call flow diagram 400 for adjusting display settings of an external display device, according to an example of the present subject matter. The various arrow indicators used in the, call flow diagram 400 depicts the transfer of data between the various entities in the system environment 300, and between the computing device 304 and the external display device 302. The order in which the call flow diagram 400 is described is not intended to be construed as a limitation, and any number of the described steps may be combined in any order to implement the call flow diagram 400, or an alternative method. Further, certain trivial steps have been omitted in the sequence diagrams, for the sake of brevity and clarity.

Referring to FIG. 4, at step 402, a power delivery (PD) controller 318 of the computing device 304 may establish a connection with the external display device 302. In an example, the external display device 302 may be a docking monitor and the PD controller 318 may establish the connection based with the external display device 302 based on a PD protocol. During establishment of the connection, the PD controller 318 may communicate with a PD controller (not shown) of the external display device 302 to perform power negotiations.

At step 404, the controller 316 of the computing device 304 may obtain a display setting for the external display device 302. In an example, the display setting may be a current display setting of an integrated display device (not shown) of the computing device 304. In another example, the display setting may be a pre-defined display setting. A user may access an interface of the computing device 304 to define the display setting of the external display device 302. For example, the controller 316 may obtain the display setting from a memory, such as a non-volatile memory of the computing device 304. In an example, the NVM may be a random-access memory (RAM) of a firmware, such as Basic Input/Output System (BIOS).

At step 406, the controller 316 may transmit the display setting obtained from the memory of the computing device 304 to the PD controller 318 of the computing device 304. In an example, the controller 316 and the PD controller 318 may be connected together by an Inter-Integrated Circuit (I2C) bus. The I2C bus is a serial protocol for two-wire interface to connect low-speed devices, like microcontrollers.

At step 408, upon receiving the display setting from he controller 316, the PD controller 318 may transmit the display setting to the external display device 302 via a PD protocol. For example, the PD controller 318 may embed the display setting in a PD protocol-based message and transmit the PD protocol-based message to the external display device 302. In an example, the PD protocol supports a vendor defined message (VDM) command. The VDM command is specific to the USB PD protocol which enables vendors to include specific commands to implement vendor-specific functionality.

Further, at step 410, the VDM command may be received by a dock controller (DC) of the external display device. The DC may route the command to a scaler board (not shown) of the external display device 302. The scaler board may adjust the display setting of a display panel (not shown) of the external display device 302 based on the display setting embedded in the VDM command.

Upon adjustment of the display setting, the external display device 302 may send an acknowledgement message to the PD controller 318, as indicated in step 412. In an example, the PD controller of the external display device 302 may communicate with the PD controller 318 of the computing device 304 to transmit the acknowledgement message.

At step 414, based on the acknowledgement message, the PD controller 318 may transmit a confirmation message to the controller 316. The confirmation message may indicate that the external display device 302 has adjusted to the display setting transmitted by the computing device 304. The controller 316 may store the display setting of the external display device 302 in the non-volatile memory of the computing device 304.

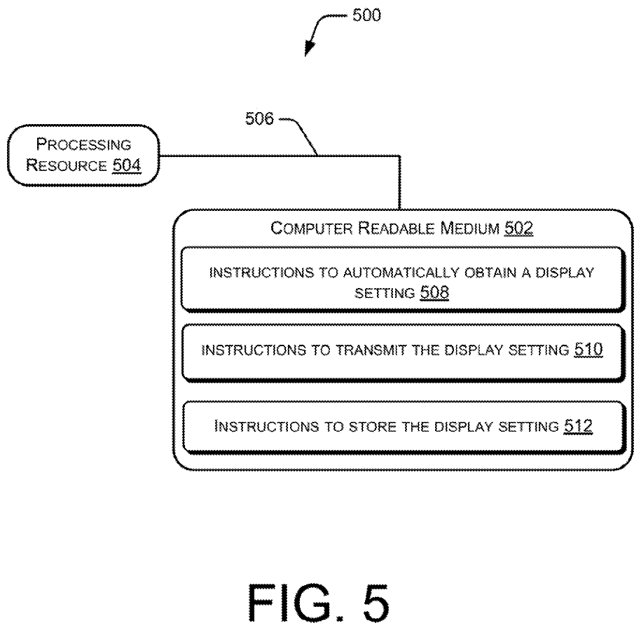

FIG. 5 illustrates an example system environment 500 using a non-transitory computer-readable medium 502 for adjusting display settings of an external display device, according to an example. The system environment 500 includes a processing resource 504 communicatively coupled to the non-transitory computer-readable medium 502 through a communication link 506. For example, the processing resource 504 may be a power delivery (PD) controller or an embedded controller of a computing system, such as the computing device, for fetching and executing computer-readable instructions from the non-transitory computer-readable medium 502.

The non-transitory computer-readable medium 502 may be, for example, an internal memory device or an external memory device. In one example, the communication link 506 may be a direct communication link, such as one formed through a memory read/write interface. In another example, the communication link 506 may be an indirect communication link, such as one formed through a network interface. In such a case, the processing resource 504 may access the non-transitory computer-readable medium 502 through a network (not shown).

In an example, the non-transitory computer-readable medium 502 includes a set of computer-readable and executable instructions for adjusting display settings of an external display device. The set of computer-readable instructions may include instructions as explained in conjunction with FIGS. 1 to 3. The set of computer-readable instructions, referred to as instructions hereinafter, may be accessed by the processing resource 504 through the communication link 506 and subsequently executed to perform acts for modifying a feature in a standby mode based on power source capacity.

Referring to FIG. 5, in an example, upon connection of an external display device to the computing device through a Universal Serial Bus (USB) Type-C port, the non-transitory computer-readable medium may include instructions 508 to automatically obtain a display setting of a display device of the computing device. In an example, a power delivery (PD) controller of the computing device may automatically obtain the display setting of the display device of the computing device. The PD controller may manage connections and messaging at the USB Type-C port of the computing device.

In an example, the PD controller may communicate with a controller, such as an embedded controller, of the computing device to obtain the display setting of the display device of the computing device. In an example, the display setting may be a current display setting of the display device of the computing device. For example, the current display setting may be a current value of display brightness, a current value of display sharpness, a current display language, and so on, that may be configured for the display device of the computing device. In another example, the display setting may be pre-defined by a user of the computing device. The display setting may include a brightness setting, a sharpness setting, a language setting, a timer setting, or a combination thereof.

The non-transitory computer-readable medium 502 may also include instructions 510 to transmit the display setting of the computing device to the external display device through a USB Power Delivery (PC) protocol. The USB PD protocol may specify a communication format based on which the PD controller may transmit the display setting to the external display device. In an example, the external display device may be a docking monitor. For example, the USB PD protocol may support a vendor defined message (VDM) command. The VDM command is specific to the USB PD protocol which enables vendors to specify undocumented commands to implement vendor-specific functionality.

The non-transitory computer-readable medium 502 may include instructions 512 to store the display setting of the external display device in a non-volatile memory (NVM) of the computing device, upon adjustment of the display setting of the external display device. In an example, the PD controller may receive a confirmation from the external display device In response to the confirmation, the PD controller may communicate with the controller to inform the controller about the adjustment of the display setting of the external display device. The controller may store the display setting in the NVM of the computing device. In an example, the NVM may be a read-only memory (ROM) of a firmware, such as Basic Input/Output System (BIOS). The controller may accordingly store the display setting of the external display device in the BIOS ROM.

Although aspects for the present disclosure have been described in a language specific to structural features and/or methods, it is to be understood that the appended claims are not limited to the specific features or methods described herein. Rather, the specific features and methods are disclosed as examples of the present disclosure.

We claim:

1. A computing device comprising:
a power delivery (PD) controller to,
transmit a display setting to an external display device via a Universal Serial Bus (USB) Power Delivery (PD) protocol upon detecting that the external display device is connected to the computing device; and
receive an acknowledgement from the external display device about adjustment of the display setting.

2. The computing device as claimed in claim 1, wherein the USB PD protocol supports a vendor defined message (VDM) command.

3. The computing device as claimed in claim 1, further comprising a display device, wherein the display setting transmitted by the PD controller corresponds to a current display setting of the display device of the computing device.

4. The computing device as claimed in claim 1, wherein the display setting corresponds to a user-defined display setting.

5. The computing device as claimed in claim 1, wherein the computing device comprises a controller to transmit the display setting to the PD controller.

6. The computing device as claimed in claim 1, wherein the display setting includes a brightness setting, a sharpness setting, a language setting, a timer setting, or a combination thereof.

7. A computing device comprising:
a display device;
a controller, coupled to the display device, to receive a display setting of an external display device coupled to the computing device; and
a Universal Serial Bus (USB) Type-C controller, coupled to the display device and the controller, to,
embed the display setting in a USB Power Delivery (PD) protocol-based message;
transmit the USB PD protocol-based message to the external display device; and
upon receiving an acknowledgement from the external display device about adjustment of the display setting, send a confirmation message to the controller.

8. The computing device as claimed in claim 7, wherein the computing device comprises a memory, coupled to the controller, to store the display setting of the external display device, upon receiving the confirmation message.

9. The computing device as claimed in claim 7, wherein the USB PD protocol supports a vendor defined message (VDM) command.

10. The computing device as claimed in claim 7, wherein the controller is to receive the display setting through a windows management instrumentation (WMI) layer.

11. The computing device as claimed in claim 7, wherein the USB Type-C controller and the controller are connected together by an Inter-Integrated Circuit (I2C) bus.

12. The computing device as claimed in claim 7, wherein the display setting includes a brightness setting, a sharpness setting, a language setting, a timer setting, or a combination thereof.

13. A non-transitory computer-readable medium comprising computer-readable instructions, which, when executed by a processing resource, cause a computing device to:
upon connection of an external display device to the computing device through a Universal Serial Bus (USB) Type-C port, automatically obtain a display setting of a display device of the computing device;
transmit the display setting to the external display device through a USB Power Delivery (PD) protocol; and
store the display setting of the external display device in a non-volatile memory (NVM) of the computing device, upon adjustment of the display setting of the external display device.

14. The non-transitory computer-readable medium as claimed in claim 13, wherein USB PD protocol supports a vendor defined message (VDM) command.

15. The non-transitory computer-readable medium as claimed in claim 13, wherein the instructions which, when executed by the processing resource, cause the computing device to, communicate with a controller of the computing device to obtain the display setting of the display device.
